(19) United States
(12) Patent Application Publication
(10) Pub. No.: US 2004/0188886 A1
(43) Pub. Date: Sep. 30, 2004

(54) Molding method for non-painting molded article of automotive outer panel and molded article thereof

(75) Inventors: Masaaki Yamashita, Utsunomiya-shi (JP); Masaaki Takahashi, Urayasu-shi (JP); Mari Kono, Tokyo (JP)

Correspondence Address: Robert E. Walter, GE Plastics, One Plastics Avenue, Pittsfield, MA, 01201, US

(73) Assignee: General Electric Company

(21) Appl. No.: 10/807,849

(22) Filed: Mar. 24, 2004

(30) Foreign Application Priority Data
Mar. 25, 2003 (JP) 2003-83555

(51) Int. Cl. B29C 45/73

(52) U.S. Cl. 264/328.16; 528/308

(57) ABSTRACT

To provide a molding method for non-painting molded article of automotive outer panel with high quality appearance and molded article thereof. The molding method for non-painting molded article of automotive outer panel (high quality appearance) is characterized by carrying out extrusion in metallic mold (wherein, T_{b}>T_{c}), where the tool temperature (T_{b}) was adjusted 0° C. to 100° C. higher than heat deformation temperature of injection thermoplastic resin, while heating. After cooling, the tool temperature (T_{c}) was lower down by 0° C. to 100° C. than heat deformation temperature of injection thermoplastic resin while extraction, during the injection molding of molten composition containing thermoplastic resin composition. Furthermore, in the invention, the extrusion is carried out in the metallic mold (wherein, T_{b}>T_{c}), and after the completion of extrusion of resin composition containing molten composition inside the mold, the mold was maintained at high pressure while carrying out extrusion. During the compression flow of extruded molten composition, the tool temperature (T_{b}) was adjusted 0° C. to 100° C. higher than heat deformation temperature of injection thermoplastic resin, while heating. After cooling, the tool temperature (T_{c}) was lower down by 0° C. to 100° C. than heat deformation temperature of injection thermoplastic resin while extraction.

The present application is a U.S. non-provisional application based upon and claiming priority from Japanese Application No. 2003-83555, with a filing date of Mar. 25, 2003, which is hereby incorporated by reference.

### TECHNICAL FIELD OF THE INVENTION

The invention relates to the molding method for non-painting molded article of automotive outer panel and the molded articles obtained by the method thereof, having high luster, outstanding abrasion resistance without the necessity for formation of clear film on the surface.

### TECHNICAL BACKGROUND OF THE INVENTION

In recent years, the auto parts are made lightweight because of social demand of resource saving, low mpg, etc. Therefore, conversion of metal into resin is progressing rapidly in most of the components.

In addition to moldability, strength, rigidity, etc., various products made of resin have been used abundantly for the main components of flat molded articles, such as door panel, pillar, etc., from the trend of recycling, unification of material, etc

The demand of lightweight automotive components is becoming severe every year, and thin wall of the molded article is tried for making lightweight molded articles. However, in order to have thin walled molded articles, in addition to the original characteristics of resin, such as strength, rigidity, etc., the improvement in moldability, or melt flowability is required corresponding to large sized components. Moreover, in order to improve the strength, rigidity of resin material, rigidity, etc., various methods, such as compounding of thermoplastic resin, addition of reinforcing agents, e.g., elastomer, glass fibre, fillers, e.g., talc, etc. are proposed.

Moreover, the surface of the molded article was very fragile, and was very difficult to get high quality appearance.

For this reason, a clear film was formed on the surface of the molded article. Furthermore, a transparent film was in-molded, and a film layer was formed on the surface of the molded article.

However, if coating or in-molding was carried out, for any additional process, the defects were detected that lead to cost up problem.

Moreover, the reuse was difficult when it was coated or film layer was formed. When it was recycled, the process of removal of coating or film was complicated. In most of the cases, it was not necessarily recycled, and was also unsatisfactory from the viewpoint of effective usage of resources.

Moreover, the door panels and pillar for automobile comprising thermoplastic resin are disclosed in Kokai no. 2000-225843 (Patent literature 1). In patent literature 1, polypropylene is used as thermoplastic resin. However, if door panels or pillar of an automobile were non-painted, the problem was abrasion resistance.

As a result to solution for conventional technology, the tool temperature was made specific heat cycle, and automotive molded articles having high quality appearance was obtained. It was found that the molded articles possessed outstanding abrasion resistance, impact resistance, and were lightweight and inexpensive.

Furthermore, when using a specific substance as resin, it was found that the substance was extremely outstanding in abrasion resistance, impact resistance, and high quality appearance was obtained.

Patent Literature 1

Kokai 2000-225843

### OBJECTIVE OF THE INVENTION

The objective of the invention is to provide molding method for non-painting molded articles of automotive outer panel and the molded articles thereof.

### SUMMARY OF THE INVENTION

The molding method for non-painting molded article of automotive outer panel (high quality appearance) is characterized by carrying out extrusion in metallic mold (wherein, T_{b}>T_{c}), where the tool temperature (T_{b}) was adjusted 0° C. to 100° C. higher than heat deformation temperature of injection thermoplastic resin, while heating. After cooling, the tool temperature (T_{c}) was lower down by 0° C. to 100° C. than heat deformation temperature of injection thermoplastic resin while extraction, during the injection molding of molten composition containing thermoplastic resin composition. Furthermore, in the invention, the extrusion is carried out in the mold (wherein, T_{b}>T_{c}), and after the completion of extrusion of resin composition containing molten composition inside the mold, the mold was maintained at high pressure while carrying out extrusion. During the compression flow of extruded molten composition, the tool temperature (T_{b}) was adjusted 0° C. to 100° C. higher than heat deformation temperature of injection thermoplastic resin, while heating. After cooling, the tool temperature (T_{c}) was lower down by 0° C. to 100° C. than heat deformation temperature of injection thermoplastic resin while extraction.

The above-mentioned thermoplastic resin is preferred to be at least one kind selected from alicyclic polyester, polycarbonate/polybutylene terephthalate, polycarbonate/polyethylene terephthalate, polybutylene terephthalate, polyethylene terephthalate.

A non-painting molded article of automotive outer panel having high quality appearance is formed by the above mentioned molding method. As non-painting molded articles of automotive outer panel, pillar, fender, door panel, and spoiler are appropriate.

### DESCRIPTIVE EXPLANATION OF THE INVENTION

Hereinafter, the molding method relating to the invention is explained briefly.

### MOLDING METHOD

Thermoplastic Resin

There are no restrictions regarding the usage of thermoplastic resin in the molding method. The thermoplastic resin is widely used for the molded articles for automobiles.

Specifically, polyolefin, such as polyethylene, rubber component based polyolefin impact resistance improving agent material, polyvinyl chloride, impact resistance improving agent polystyrene, acrylonitrile-styrene copolymer, acrylonitrile-styrene-butadiene copolymer (ABS resin), polycarbonate, alloy polymer of polycarbonate-ABS resin, alloy polymer of polycarbonate-polystyrene, alloy polymer of polycarbonate-polyester, alloy polymer of polycarbonate-polyamide, modified polyphenylene ether resin, mixture of polystyrenes, polyamide, such as nylon, alloy polymer containing polyamide, polyoxymethylene, polyethylene terephthalate, polybutylene terephthalate, various crystalline polymer, etc. are listed.

Among these, at least one kind selected from polycarbonate/polybutylene terephthalate, polycarbonate/polyethylene terephthalate, polybutylene terephthalate, polyethylene terephthalate, is preferred. Furthermore, alicyclic polyester can be used; polycyclohexanedimethanolcyclohexane dicarboxylate (hereinafter, abbreviated to PCCD) can also be used.

Polycondensation reaction product of terephthalic acid and its derivative, and 1,4-butanediol can be used as polybutylene terephthalate. Polycondensation reaction product of terephthalic acid and its derivative, and ethyelene glycol can be used as polyethylene terephthalate.

The molecular weight of polyethylene terephthalate (PET) and polybutylene terephthalate (PBT) should be in the range that do not impair the properties of the molded article, moreover, it needs to be optimized by the kind of thermoplastic polyester to be used. The preferred weight average molecular weight 10,000 to 200,000, preferably 20,000 to 150,000 represented by polystyrene conversion by GPC measurement. If weight average molecular weight is in the above-mentioned range, the mechanical properties of the molded article are outstanding during the molding, and moldability is excellent.

When an alloy of polycarbonate (PC) and polyethylene terephthalate (PET), or an alloy of polycarbonate (PC) and polybutylene terephthalate (PBT) is used, there are no restrictions regarding the weight ratio of PC:PET, or PC:PBT, the desirable range is (1):(99) to (99):(1), preferably (2):(98) to (98):(2).

As polypropylene resin used in the invention, homopolypropylene, block copolymer of propylene and other olefin, random copolymer of propylene and other olefin less than number weight %, furthermore acid modified polypropylene modified by unsaturated carboxylic acid or its derivatives.

Polyester having repeating units represented by the following general formula (I) is used as alicyclic polyester resin.

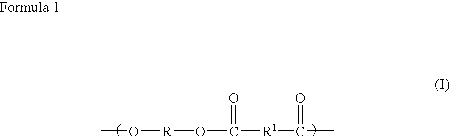

Wherein, R is bivalent residual derived from diol, R¹ is bivalent residual derived from divalent acid (divalent carboxylic acid), at least one of R or R¹ is the group having cycloalkyl ring.

Specifically, R is aryl, alkane, or cycloalkane residual group including diol having 6 to 20 carbon atoms, at least one of R or R¹ is alicyclic group. It is desirable that both R and R¹ are alicyclic group.

The specific example of alicyclic polyester is polycyclohexanedimethanol cyclohexanedicaraboxylate (PCCD).

Other Components

The molded articles for automotive outer panel blended with thermoplastic resin composition may contain additive agents during molding method.

Conjugate diene or acrylic elastomer of acrylic acid or methacrylic acid modified product, or aromatic vinyl copolymer are used as impact resistance improving agent.

Generally, impact resistance improving agent includes butadiene or isoprene, butyl acrylate, or structural unit derived from aromatic vinyl compound, if required. The concrete examples are ethylene-vinyl acetate, ethylene-ethyl acrylate copolymer, SEBS (styrene-ethylene-butylene-styrene) and SBS (styrene-butadiene-styrene)block copolymer, EPDM (ethylene-propylene-diene-monomer), EPR (ethylene-propylene-rubber) copolymer, etc. The impact resistance-improving agent is blended in the ratio less than 20% by weight to total weight of resin composition.

The resin composition may also contain mold release agent, antioxidant, stabilizer, UV absorbent, etc.

The examples of mold release agent are silicon mold release agent, e.g., methylphenyl silicon oil; carboxylate of multivalent alcohol, e.g., pentaerythritol tetrastreate or glyceryl monostearate, montanic acid wax; olefin mold release agent, e.g., poly-α-olefin or its derivative, etc.

The examples of suitable stabilizer are acidic phosphate, alkyl phosphate, aryl phosphate, or mixed phosphate having at least one hydrogen or alkyl group, phosphates of IB or IIB metals, oxaphosphate, acidic pyrophosphate or their mixture. The amount to be used is required to optimize by the amount of polyester component, polycarbonate component, respectively.

Benzotriazole, benzophenone, salicylate UV absorbent can be used as UV absorbent. Moreover, epoxy stabilizer may also be used.

In addition, organic and inorganic phosphorous or thioester stabilizer, thiol, metallic salts can also be used as stabilizer.

The resin composition can be blended with well known additive agents, such as pigment (carbon black, titanium oxide, etc.), filler, reinforcing agents (glass fibre, carbon fibre, aramid fibre, kepler fibre, polyarylate fibre, talc, clay, mica, glass flakes, milled glass, glass beads, etc.), lubricant, plasticizer, flame retardant, flow improving agent, etc. during mixing or molding in the range that do not impair the characteristics of resin composition.

The amount of additive agent is selected on the basis of the amount of resin components.

It is desirable to blend glass fibre to improve the impact resistance of the molded articles. As glass fibre, fibres with different lengths can be used. The average length of a glass fibre used in the invention is 1 to 15 mm, preferably 2 to 12 mm. Therefore, if the average length of the glass fiber in the molded article were maintained, there would be no restriction as molding material. However, in order to maintain the glass fiber length a certain level, generally, the length is 2 to 100 mm, preferably 3 to 50 mm. It is desirable to use glass fibre reinforced polypropylene resin pellets having glass fibre content 20 to 80% by weight, where glass fibres of length equal to total length are arranged parallel to each other. As glass fibre, E-glass, S-glass fibres are listed. The average fibre diameter is less than 25 μm, preferably in the range of 3 to 20 μm, but it can be moulded easily and have excellent flowability. The glass fibres are surface treated with coupling agents in order to improve the miscibility with the resin. The coupling agent can be selected from silane, titanium-coupling agents.

The resin composition may contain foaming agent, if required. There are no restrictions regarding the foaming agent, it may be a chemical or physical foaming agent that produces gas on decomposition by heating at the fusion temperature of each resin material. Oxalic acid derivative, azo compound, hydrazine derivative, semicarbazide, azide compound, nitroso compound, triazole, urea and their related compound, nitrite, hydride, carbonate, and bicarbonate are used as chemical foaming agent. Pentane, butane, fluoro compound, water, carbon dioxide gas, nitrogen gas, etc. are used as physical foaming agent.

Molding Method

The molding method for non-painting molded article of automotive outer panel, wherein the above mentioned thermoplastic resin containing composition is melted (called as molten composition), the resin composition is extruded in the metallic mold, where the tool temperature (T_{b}) was adjusted 0° C. to 100° C. higher than heat deformation temperature of injection thermoplastic resin, while heating. After cooling, the tool temperature (T_{c}) was lower down by 0° C. to 100° C. than heat deformation temperature of injection thermoplastic resin while extraction. When tool temperature is adjusted by such kind of hot and cool cycle, there is no occurrence of mark on the molded article surface, the surface condition is of good quality, and it is very easy to de-mold from a metallic mold.

Furthermore, after the completion of extrusion of molten composition inside the mold, the mold was maintained at high pressure and extruded molten composition can be subjected to compressed flow, during extrusion molding.

The tool temperature control system used in the invention stops the cold water, cooling oil and uses hot water, heating oil, or electrical heater independently or together while heating. While lowering down the temperature, the hot water, heating oil, or electric current to an electrical heater is stopped, and cooling oil is passed through the same pipeline for adjusting tool temperature, or through different pipelines. Such kind of mold system is shown in FIG. 1 (shown below). During this time, the temperature of hot water, heating oil used for the heating, is very high, and the temperature of cold water, cooling oil used for lowering the temperature, is very low, and further, if volume flow is very high, then molding cycle can be reduced. Regarding the electrical heater, high electrical density is preferred. Regarding tool temperature regulation pipeline, multiple pipelines are arranged without the metallic mold strength problem, the efficiency can be improved and molding cycle can also be reduced.

The time required to increase the tool temperature by 0° to 100° C. than heat deformation temperature of thermoplastic resin can be a part of time period required for carrying out extrusion in the metallic mold till its completion. The other time periods are not restricted.

It is desirable to carry out sudden heating and/or sudden cooling with temperature gradient 5 to 12° C./min during molding. For this reason, a metallic mold has built-in electric heater for heating. Moreover, the timing to start heating and lowering the tool temperature between the molding cycle can be controlled arbitrarily. Precisely, a temperature sensor embedded inside a metallic mold, or preset timer can note the temperature, and move to next cooling process. Moreover, it is also possible to delay the time of cooling process by the timer.

Hot water, eating oil, etc. are mentioned as heating mediums used to heat a metallic mold. As a cooling medium, it is desirable to use either cold water or cooling oil to lower down the temperature of metallic mold.

The above-mentioned system used to heat or cool the metallic mold, and tool temperature regulator can be used together, or as separate systems to carry out molding.

In the invention, the above-mentioned thermoplastic resin containing molten composition is supplied to the cylinder of an injection-molding machine.

The cylinder of an injection-molding machine is equipped with screw, cylinder, and can control the high temperature and high pressure.

FIG. 1 is a block diagram showing the rough format of tool temperature control system used for molding method.

In tool temperature control system, a temperature control system machine 1 for hot water and a chiller 2 for cooling water are arranged, and each one is connected to a switchover unit 3. In switchover unit 3, there is an outlet 5 to supply cold and hot water to metallic mold, and recovery opening 6 to recollect. In order to attain desirable tool temperature, the switchover unit 3 is controlled in such a way that each switchover valve is in suitable condition V_{IN} and V_{R}.

FIG. 2 is a sectional view of a metallic mold. In a metallic mold, a cavity 9 is formed in the overlap surface of fixed side 7 and movable side 8. The fixed side 7 is fitted with spoiler 10 and gate 11 in order to fill molten resin in cavity 7. The cavity portion inside a metallic is kept vacant to have desirable molded article shape.

According to the invention, during the extrusion of molten resin, it can be filled up with sufficient molten state, without cooling molten resin rapidly and raising the temperature higher than heat deformation temperature. Thus, by filling up with the molten state, jet or weld line can be removed, and transcription rate of a metallic mold can be improved considerably along with the improvement in the gloss of a molded article. The buoyant of filler is completely lost, even if it is filled up with inorganic filler, and a molded article with good appearance equivalent to unfilled material can be obtained.

Moreover, the flowability of resin can also be improved. In addition, when blending agent is dispersed randomly, a molded article with high abrasion resistance can be obtained.

Moreover, foaming gas can be blown at the time of extrusion, or a foaming agent can be blended with molten composition beforehand, if required, and the molded article can be made sparkly.

Molded Article

The non-painting molded article of automotive outer panel is manufactured by the above-mentioned method. Automotive constitutional components are made up of resin, and can be applied to essential flat components.

The ideal molded articles are pillar, fender, door panel, spoiler, etc.

Since the non-painting molded article of automotive outer panel is manufactured by a specific method, the surface excels in abrasion resistance, and cannot be scratched easily. Furthermore, formation of clear film is not required because of high quality appearance.

A door panel usually has the area corresponding to metal sheet, and has the shape that has space where functional parts can be inserted in the middle. Moreover, other than flat essential components, the formation of convex parts, such as an armrest, is common. On the other hand, as pillar, there are front pillar, center pillar, rear quarter pillar, etc., and the metal sheet supporting a ceiling portion is attached to an automobile main body. Moreover, a fender is a mud flap cover of a wheel. Moreover, spoiler is a fixed board installed in the rear upper part, and acts as a stabilizer for increasing driving force using air flow, or installed in the front lower part to prevent surfacing of the body at the time of high speed.

Since, it has essential flat components, specifically, flexural strength, flexural rigidity, impact strength, heat resistance, and common characteristics are essential.

Moreover, since it is not necessary to form clear film in the invention, it is possible to recycle waste molded articles or substandard molded articles, which is desirable from the viewpoint of effective usage of resources.

In addition, the thickness of the molded article is selected on the basis of automobile kind, or components using those molded articles.

### RESULT OF THE INVENTION

According to the molding method of the invention, it is possible to obtain molded articles for automotive outer panel having good surface appearance because of specific heat cycle treatment in metallic mold. There is no need of formation of clear film on the molded article. Furthermore, the molded article possessing outstanding impact resistance, and abrasion resistance can be obtained.

Embodiment

Hereinafter, the invention is explained with the help of embodiments, but the scope of the invention is not limited to these embodiments.

The following resin materials were used in the embodiments and comparative examples.

Alicyclic Polyester

Polycyclohexanedimethanol cyclohexanedicarboxylate (PCCD) was used as alicyclic polyester.

Polycarbonate (PC) Lexan 105, GE Plastics, Japan product was used as PC.

Alicyclic Polyester Resin Composition

The resin composition obtained by melting and kneading the above mentioned PCCD: 30 parts by weight, PC (Lexan 105): 70 parts by weight was used as alicyclic polyester resin composition.

Polyester Alloy

Mixed composition of polycarbonate and polyethylene terephthalate in the weight ratio 70:30 was used as PC/PET alloy.

Mixed composition of polycarbonate and polybutylene terephthalate in the weight ratio 70:30 was used as PC/PBT alloy.

Embodiment 1 to 3

Molding

The above mentioned each resin (embodiment 1,2, and 3) was heated and melted, and was filled in the mold of molding apparatus having control system shown in FIG. 2.

The tool temperature (T_{b}) was raised to 140° C. by heating, and injection molding was carried out after lowering the tool temperature (T_{c}) to 40° C. during extraction. After the initiation of injection molding of resin composition, movable mold was progressed and filled in the metal cavity. After the extrusion, the movable metallic mold was retreated, cooled and the metallic mold was opened wide, and a molded article was obtained.

Molding Conditions

Molded article pattern: Box type 150×8×12 mm

Mold resin temperature: 260° C.

Extrusion speed: Medium

Hue Evaluation

The chroma saturation C, luminosity L, gloss G of each sample of 100 mm×100 mm×3 mm was evaluated after and before abrasion resistance test using calorimeter or glossmeter.

In addition, abrasion resistance was evaluated by comparing the surface condition of the sample before and after the test by rubbing polypropylene brush against the above-mentioned surface of a sample with fixed speed.

The measure of abrasion resistance is as follows.

Excellent . . . ∘

Good . . . Δ

Bad . . . x

Appearance

The appearance is evaluated as follows.

Excellent . . . ∘

Good . . . Δ

Bad . . . x

The results are shown in Table 1.

### COMPARATIVE EXAMPLES 1 TO 3

Molding

The above mentioned each resin (embodiment 1, 2, and 3) was heated and melted, and was filled in the mold of molding apparatus having control system shown in FIG. 1. The tool temperature (T_{b}) was raised to 50° C. by heating, after cooling, the injection molding was carried out at tool temperature (T_{c}) 50° C. during collection. The injection molding was carried out same as embodiment.

The obtained molded articles were evaluated.

The results are shown in table 1.

TABLE 1

| | | | | Comparative | Comparative | Comparative |
|---|---|---|---|---|---|---|
| | Embodiment 1 | Embodiment 2 | Embodiment 3 | example 1 | example 1 | example 3 |
| Resin | PC/alicyclic | PC/PET | PC/PBT | PC/alicyclic | PC/PET | PC/PBT |
| composition | polyester | | | polyester | | |
| Tool | 140 | 140 | 140 | 50 | 50 | 50 |
| temperature | | | | | | |
| during heating | | | | | | |
| Tool | 40 | 40 | 40 | 50 | 50 | 50 |
| Temperature | | | | | | |
| during extraction | | | | | | |
| Abrasion test | ◯ | ◯-Δ | ◯-Δ | X | X | X |
| Appearance | ◯ | ◯ | ◯ | Δ | X | X |

### SIMPLE EXPLANATION OF THE FIGURE

FIG. 1

It is a block diagram showing temperature control system used in the molding method.

FIG. 2

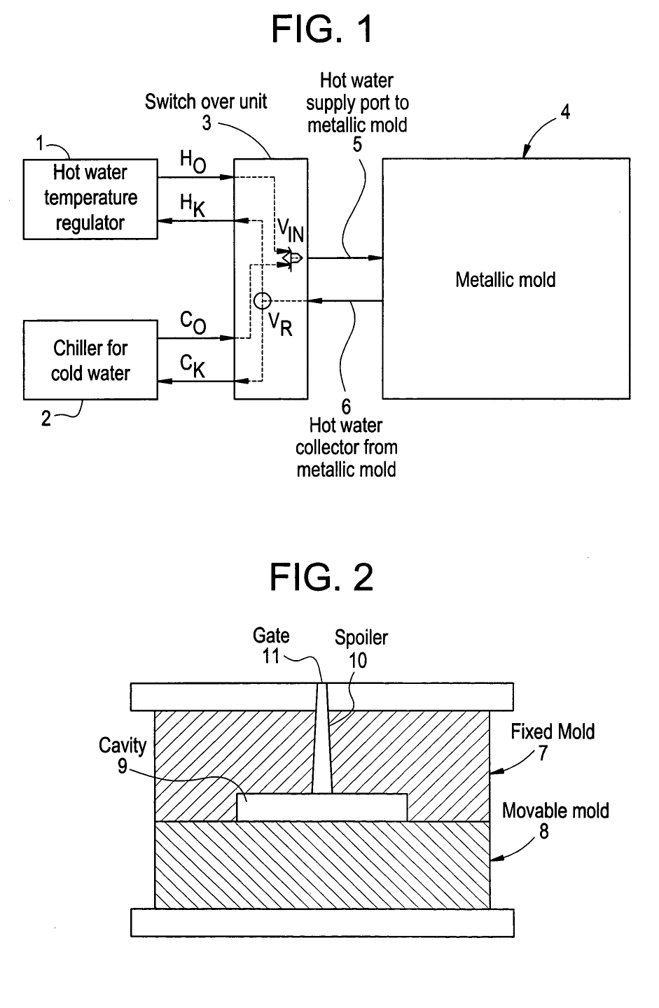

It is a sectional view showing the embodiment example of the metallic mold suitable for molding method.

### EXPLANATION OF REFERENCE LETTERS

1 Hot water temperature regulator

2 Chiller for cold water

3 Switch over unit

4 Metallic mold

5 Hot water supply port to metallic mold

6 Hot water collector from metallic mold

7 Fixed mold

8 Movable mold

9 Cavity

10 Spoiler

11 Gate

1. The molding method for non-painting molded article of automotive outer panel (high quality appearance) is characterized by injection of the material in a metal mold (wherein, T_{b}>T_{c}), where the tool temperature (T_{b}) was adjusted 0° C. to 100° C. higher than heat deformation temperature of injection thermoplastic resin, while heating. After cooling, the tool temperature (T_{c}) was reduced by 0° C. to 100° C. less than heat deformation temperature of injection thermoplastic resin while extraction, during the injection molding of molten composition containing thermoplastic resin composition.

2. The molding method for non-painting molded article of automotive outer panel is characterized by injection of the material in a metal mold (wherein, T_{b}>T_{c}), and after the completion of extrusion of resin composition containing molten composition inside the metallic mold, the mold was maintained at high pressure while carrying out extrusion. During the compression flow of extruded molten composition, the tool temperature (T_{b}) was adjusted 0° C. to 100° C. higher than heat deformation temperature of injection thermoplastic resin, while heating. After cooling, the tool temperature (T_{c}) was reduced by 0° C. to 100° C. less than heat deformation temperature of injection thermoplastic resin during extraction.

3. The molding method for non-painting molded article of automotive outer panel mentioned in claim 1 or 2, wherein the above-mentioned thermoplastic resin is at least one kind selected from alicyclic polyester, polycarbonate/polybutylene terephthalate, polycarbonate/polyethylene terephthalate, polybutylene terephthalate, polyethylene terephthalate.

4. A non-painting molded article of automotive outer panel having high quality appearance is formed by the molding method mentioned in any of claims 1 to 3.

5. A non-painting molded articles of automotive outer panel mentioned in claim 4 are pillar, fender, door panel, and spoiler.
